(19) United States
(12) Patent Application Publication
(10) Pub. No.: US 2026/0338267 A1
(43) Pub. Date: Oct. 29, 2026

(54) DIFFERENTIAL UNIT AND ELECTRIC DRIVE WITH SUCH A DIFFERENTIAL UNIT

(71) Applicant: GKN Automotive Limited, Birmingham (GB)

(72) Inventors: Colin Zaers, Lohmar (DE); Hans-Joachim Schmeink, Lohmar (DE); Mark Schmidt, Lohmar (DE); Artur Grunwald, Lohmar (DE); Marco Wimmershoff, Lohmar (DE)

(21) Appl. No.: 19/653,227

(22) Filed: Apr. 21, 2026

(30) Foreign Application Priority Data
Apr. 25, 2025 (DE) 102025116050.3

(51) Int. Cl. F16H 48/22; B60K 17/02; F16H 37/08; F16H 48/08; F16H 57/037; F16H 48/34; F16H 57/02

(52) U.S. Cl. CPC F16H 48/22; B60K 17/02; F16H 37/0813; F16H 48/08; F16H 57/037; F16H 48/34; F16H 2048/343; F16H 2057/02034; F16H 2057/02052

(57) ABSTRACT

A differential unit comprising a rotatably drivable differential housing, a differential case rotatably mounted therein, a plurality of differential gears and two output parts drivingly connected thereto, a disconnect clutch between the differential housing and the differential case, which is arranged axially between a wall section of the differential housing and a wall section of the differential case, a locking clutch for locking an equalizing movement of the output parts, an actuator assembly with at least one setting ring for actuating the disconnect clutch and locking clutch, wherein the wall portion of the differential housing has through-openings through which force transmission portions extend from the setting ring for actuating the disconnect clutch and the locking clutch. The disclosure also relates to an electric drive with such a differential unit.

### CROSS REFERENCE TO RELATED APPLICATIONS

This application claims priority to German Patent Application No. 102025116050.3 filed on Apr. 25, 2025, and the content of this priority application is incorporated herein by reference in its entirety.

### TECHNICAL FIELD

The disclosure relates to a differential unit and an electric drive with such a differential unit.

### BACKGROUND

A drive assembly with a differential unit for a multi-axle motor vehicle is known from DE 10 2008 063 904 A1. The differential unit comprises an externally controllable engaging clutch for drivingly connecting the differential unit to a drive source, and an externally controllable locking clutch for locking the balancing movement between the two output parts of the differential unit. The engaging clutch and the locking clutch are arranged coaxially to the axis of rotation and are designed in the form of friction disc clutches. One drive is provided for actuating the engaging clutch and the locking clutch.

Document DE 10 2022 129 620 B4 discloses a differential unit with a shift clutch designed as a form-fitting clutch for drivingly connecting or disconnecting the differential unit and a locking clutch designed as a form-fitting clutch for locking the balancing movement of the differential. A controllable actuator unit is provided with a ramp mechanism for actuating the shift clutch and a ramp mechanism for actuating the locking clutch. The two ramp mechanisms can be operated in such a way that the shift clutch is engaged first, and then the locking clutch is engaged.

From US 11 174 928 B2 a differential gearing is known with a drive element, a differential gear set, a first clutch in the form of a friction disc clutch for limiting the differential movement, and a second clutch in the form of a form-fitting clutch for connecting the drive element to one of the output gears of the differential gear set. A ball ramp mechanism is provided to operate the clutches.

Document DE 10 2018 007 237 A1 discloses an axle drive for a motor vehicle, which comprises a rotatingly drivable differential housing, a differential case rotatable therein and a differential gear set. A coupling element is arranged on the differential housing so as to be rotationally fixed and axially displaceable in three shift positions. The coupling element comprises a coupling ring, which has a first ring gear for rotationally fixedly coupling the differential housing and differential case, and a second ring gear for rotationally fixedly coupling the differential housing and an axle bevel gear. The coupling element is moved by an actuator, which can be designed as an electromagnetic actuator or as a shift motor actuator.

From US 11,118,664 B2 a differential assembly is known comprising a differential input member, a differential gear set, a first clutch and a second clutch. The first clutch is designed as a friction disc clutch and is operatively arranged between the differential input member and one of the side gears of the differential. The second clutch is designed as a form-fitting clutch and can be selectively operated in order to connect one of the side gears to the differential input member in a rotationally fixed manner. The two clutches can each be actuated by an actuator configured as ball ramp assembly.

A clutch arrangement for a differential is known from US 2018/0106353 A1, with two multi-disc clutches and two ball ramp assemblies for actuation.

An object of at least some implementations of the present disclosure is to propose a differential unit for a drive axle of a motor vehicle, in particular for an electrically driven drive axle of a multi-axle driven motor vehicle, that has a compact design and high efficiency and enables good driving dynamics. The object is further to propose an electric drive with such a differential assembly that is efficient, compact and versatile in terms of driving dynamics.

### SUMMARY

For this, a differential unit for a drive axle of a motor vehicle is proposed, comprising a differential housing which is rotatingly drivable about an axis of rotation; a differential case rotatably mounted in the differential housing; a plurality of differential gears rotating with the differential case and two output parts drivingly connected to the differential gears, the two output parts having a balancing, i.e. differential effect on one another; a controllable disconnect clutch for disconnecting or connecting a torque transmission from the differential housing to the differential case, wherein the disconnect clutch is designed as a form-fitting clutch and is arranged axially within the differential housing between a wall section of the differential housing and a wall section of the differential case; a controllable locking clutch for limiting a differential movement between the two output parts, wherein the locking clutch is designed in the form of a friction disc clutch which has outer discs connected to the differential case in a rotationally fixed manner and inner discs connected to one of the output parts; an actuator assembly with at least one axially movable setting ring for operating the disconnect clutch and the locking clutch, wherein the differential housing has a wall section with through-openings through which force transmission portions extend for transmitting force from the setting ring for operating the disconnect clutch and the locking clutch.

The differential unit efficiently combines two functions in one unit, namely a disconnect function and a locking, i.e. limit-slip function, wherein both clutches are arranged in the differential housing which is rotatingly drivable. In this respect, the differential unit can also be referred to as an integrated disconnect limited slip differential (IDLSD), or generally also as a differential clutch assembly. The integrated disconnect limited slip differential offers a disconnect function in combination with the full range of vehicle dynamics of an actively controlled friction clutch limited slip differential, particularly for electric drives.

The disconnect clutch is designed as a form-fitting clutch, that can also be referred to as positive locking clutch. This includes clutches in which torque is transmitted by positive engagement of a first clutch part and a second clutch part. Examples of form-fitting clutches are dog clutches, claw clutches or tooth clutches. The locking clutch is designed as a friction clutch, i.e. torque is transmitted by friction. Preferably, the friction clutch can be used to realize any intermediate position between an open position, in which no significant locking torque is transmitted between the clutch input part and the clutch output part, and a closed position, in which a maximum locking torque is applied between the two clutch parts.

When the disconnect clutch is open, i.e. when the driveline is switched off, no losses occur in the friction clutch as it rotates together with the drive axle. Only low actuating forces are required to engage the disconnect clutch, which has a positive effect on the design of the actuator system. When the disconnect clutch is engaged, i.e. in a closed state, the locking torque can be precisely controlled by means of the friction clutch. In addition, the friction clutch limits the transmittable torque and thus protects the drive assembly from overload, especially when it is operated as a limited-slip differential. With the aforementioned advantages, the differential unit with a disconnect and actively controllable locking function is particularly suitable for a secondary axle of an electrically powered motor vehicle. The primary axle can also be driven electrically or conventionally by means of an internal combustion engine. However, it is understood that the differential unit can also be used in a conventional driveline with an internal combustion engine as the drive source.

The actuator assembly can have one single actuator drive, i.e. motor for operating both, the disconnect clutch and the locking clutch. In a first embodiment, only one setting ring, i.e. output ring can be provided with which both clutches are set. Alternatively, a first setting ring for the disconnect clutch and a second setting ring for the locking clutch can be provided, which are arranged coaxially to each other outside the differential housing. In this case, the differential housing has two sets of through openings through which first force transmission portions for operating the disconnect clutch and second force transmission portions for operating the locking clutch extend accordingly.

The actuator assembly with only one motor can be designed such that the setting of the disconnecting or connecting function of the disconnect clutch and the setting of the transmittable locking torque of the locking clutch are performed in an actuation sequence. For example, a ramp mechanism with an input ring with two ramps on two diameters and two output rings with corresponding counter-ramps for controlling the two functions can be provided for this purpose, which will be discussed in greater detail below. However, it is also possible for the disconnect clutch and the locking clutch to be actuated by separate actuators.

The actuator assembly is controllable, in particular electrically controllable, such that various operating states can be realized, which bring advantages in terms of driving dynamics, in particular when used in an electrically drivable drive axle. In a first operating state, the disconnect clutch and the locking clutch are both open so that no torque can be transmitted to the two output parts of the differential unit. In this operating state, the differential gearing runs idly with the axle, with a differential, i.e. compensating movement between the output wheels, respectively the side shafts being possible.

In a second operating state, the actuator assembly can be controlled starting from the first operating state such that the disconnect clutch is closed and the locking clutch is open. In this operating state, the differential is driven by the motor and transmits the input drive power to the two output parts, and the side shafts, respectively. The differential operates as a so-called open differential, i.e. the two output parts and side shafts, respectively, have a differential or compensating effect on each other’s rotational movement.

In a third operating state, the actuator assembly can be controlled starting from the second operating state such that, when the disconnect clutch is engaged, the locking clutch is operated to generate a locking torque between the two output members of the differential. The control can take place in two stages, i.e. in a first sub-step, the disconnect clutch is first closed, and in a second sub-step, the locking clutch is operated in order to set the desired locking torque. With the aid of the actuator assembly, the transmissible locking torque can be set and controlled according to driving dynamics requirements. Furthermore, torque can be transmitted to the differential output members, respectively vehicle wheels, with limited slip. Overall, the driving dynamics of the vehicle can thus be significantly improved, especially when used in an electric drive. When the two clutches are opened again by the actuator assembly, the differential gearing and the locking clutch rotate freely again. The friction losses that occur in the disconnected state are low, as the friction clutch and the open differential rotate jointly as a single unit.

The actuator assembly can further be designed to establish a further operating state in the differential, wherein the disconnect clutch is opened and the locking clutch is closed in order to generate a locking torque. In this way, when the drive axle is decoupled, a demand-controlled slip torque can be set in the locking clutch between the two output parts, respectively the two vehicle wheels connected thereto; or, when the locking clutch is fully closed, the two output parts can rotate as a single unit with the differential case. The vehicle wheels are thus locked together, which can provide a driving dynamics advantage in certain driving situations. For example, when cornering, a locking torque can be generated between the differential output members, respectively the two vehicle wheels connected thereto, so that the wheel on the outside of the bend is braked. An oversteering vehicle can be stabilized, or the secondary drive axle can be prevented from breaking away. Overall, this design contributes to an increase in driving safety and an improvement in driving dynamics.

According to an embodiment, the actuator assembly can have a ramp mechanism which comprises an axially supported support ring and, axially movable in relation thereto, a first setting ring and a second setting ring. The support ring, the first setting ring and the second setting ring can each have several ramps with variable depth over the circumference, which are designed to convert a rotary movement initiated by the actuator motor into an axial movement of the first and/or second setting ring as required.

Relative rotation can be realized, for example, by the support ring being rotatingly driven by the actuator drive, while the two setting rings, on the other hand, are arranged to be arranged in a rotationally fixed but axially movable manner. It is also possible to realize an inverted design in which the setting ring is held in a rotationally fixed manner and the support rings are rotatingly drivable.

Preferably, at least the ramps of the second setting ring for the locking clutch and the ramps of the support ring that co-operate therewith are designed in the form of ball grooves with variable depth over the circumference, in each of which a ball is accommodated. The setting ring is axially supported against the support ring via the balls. The ramps of the first setting ring for the disconnect clutch and the interacting ramps of the support ring can be designed as sliding ramps that are axially supported directly against each other, i.e. without rolling elements arranged in between. This results in an axially compact design with a low number of parts. Alternatively, the interacting ramps of the first setting ring and the support ring can also be designed as ball ramps with balls arranged between them.

The ramps, respectively ball grooves of the support ring as well as the corresponding ramps, respectively ball grooves of the first and second setting rings, are designed in particular such that, starting from a neutral or zero position, the disconnect clutch is closed by rotating in a relative direction and, once the disconnect clutch is closed, the locking clutch is also closed upon further relative turning. In this way, the locking torque can be adjusted according to requirement by means of the angle of rotation.

In a modified, supplementary design, the ramps can be designed such that, again starting from the neutral or zero position, by rotating in an opposite second direction of rotation, the locking clutch can be closed as required, while the disconnect clutch remains open.

According to an embodiment, the disconnect clutch can be designed to transmit torques of more than 1500 Nm, in particular more than 2000 Nm, and up to 5000 Nm (nominal torque). The locking clutch can be designed to generate locking torques of more than 1000 Nm and less than 2500 Nm.

Other possible embodiments are that a mean engagement diameter of the disconnect clutch can be larger than a mean engagement diameter of the locking clutch. Alternatively or additionally, the disconnect clutch and the locking clutch can partially overlap radially. This means that a smallest engagement diameter of the disconnect clutch can be smaller than a largest engagement diameter of the locking clutch. It is understood, however, that the disconnect clutch can also be arranged radially outside the locking clutch.

In an embodiment, the disconnect clutch can be arranged axially between a side wall portion of the differential housing and a side wall portion of the differential case. In an alternative embodiment, the coupling ring of the disconnect clutch can also carry an internal toothing and be brought into engagement with an external toothing provided on the outer circumference of the differential case.

The object is further solved by an electric drive for a secondary drive axle of a motor vehicle, comprising: an electric machine, a reduction gearing arranged in the power path downstream of the electric machine, and a differential unit arranged in the power path downstream of the reduction gearing, with the differential unit designed according to one or more of the above-mentioned embodiments, wherein the differential unit transmits a rotary motion generated by the electric machine and introduced via the interposed reduction gearing to the two output parts for driving a respective side shaft.

The electric drive offers analogous advantages to the differential unit. A disconnect function is provided in a favorable manner in combination with the full scope of performance for driving dynamics control by means of an actively controlled friction clutch with only one setting motor. When the electric motor is switched off, the friction losses are low.

The electric machine can have a stator and a rotor that is rotatingly drivable relative thereto. The rotor drives the reduction gearing via a rotor shaft. The rotor axis is preferably arranged parallel to the axis of rotation of the differential unit.

### BRIEF DESCRIPTION OF THE DRAWINGS

Certain embodiments are explained below with reference to the drawing figures. Herein:

FIG. 1 shows a differential unit in a first embodiment in longitudinal section;

FIG. 2 schematically shows the functional relationship when actuating an exemplary actuator assembly for a differential unit as shown in FIG. 1;

FIG. 3 a first embodiment of an input or support ring for a differential unit according to FIG. 1 in axial view of the ball grooves, with groove profiles of a first and second ball groove for actuating the disconnect and/or locking clutch shown;

FIG. 4A shows the differential unit according to FIG. 1 in a first operating state with the disconnect clutch open and the locking clutch open;

FIG. 4B shows the differential unit as shown in FIG. 1 in a second operating state with the disconnect clutch closed and the locking clutch open;

FIG. 4C shows the differential unit as shown in FIG. 1 in a third operating state with the disconnect clutch closed and the locking clutch engaged;

FIG. 5 shows a second embodiment of an input or support ring for a differential unit according to FIG. 1 in axial view of the ball grooves, with groove profiles of a first and second ball groove for actuating the disconnect or locking clutch shown;

FIG. 6 shows a drive assembly with a differential unit as shown in FIG. 1;

FIG. 7 shows a differential unit in a modified second embodiment in longitudinal section; and

FIG. 8 shows a differential unit in a further embodiment in longitudinal section.

### DETAILED DESCRIPTION

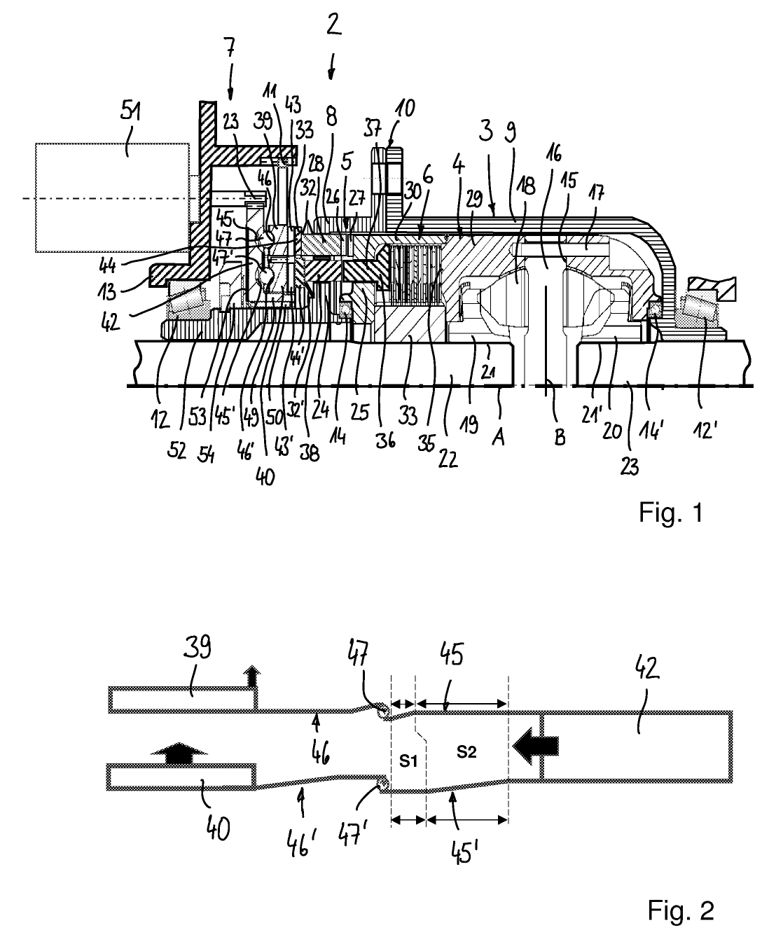

FIG. 1 shows a differential unit 2 in a first embodiment. The differential unit 2 comprises a differential housing 3, which can be driven to rotate about an axis of rotation A, a differential case 4 rotatably mounted in the differential housing 3 with a differential gear set received therein, a disconnect clutch 5 for drivingly connecting or disconnecting the differential case 4 to or from the differential housing 3, a locking clutch 6 for locking an equalizing or differential movement of the differential gear set, and an actuator assembly 7 for actuating, respectively operating the disconnect clutch 5 and the locking clutch 6.

The differential housing 3 can, for example, be constructed in two parts and comprise a first pot-shaped housing part 8 and a second pot-shaped housing part 9, which can be connected to a drive gear in the region of their flange portions 10 on their opening sides. The differential housing 3 can be rotatably mounted about the axis of rotation A by means of a first housing bearing 12 and a second housing bearing 12' in a stationary housing 13 (only partially shown). In the differential housing 3, the differential case 4 is rotatably mounted about the axis of rotation A by two bearings 14, 14', without being restricted thereto. A plain bearing is also possible, for example. The differential case 4 can also be referred to as differential case or carrier.

The differential case 4 has openings 15 into which a bolt 16 is inserted and fixed, for example, by means of a locking pin 17. At least one differential gear 18 is rotatably mounted on the pin 16 about a pin axis B. Preferably, a plurality of differential gears 18 are provided, which rotate together with the differential case 4 about the axis of rotation A and are in meshing engagement with the first and second output parts 19, 20 of the differential. The two output parts 19, 20 are designed as side shaft gears and are arranged coaxially to the axis of rotation A. Due to the meshing with the rotating differential gears 18, the two output parts 19, 20 have an equalizing effect on each other, i.e. if one of the two output parts rotates faster, the other rotates correspondingly slower, and vice versa. This effect may also be referred to as balancing or differential effect.

The two output parts, respectively side shaft gears 19, 20 each have splines 21, 21', into which a corresponding mating splines of an intermediate shaft or drive shaft 22, 22' is engaged to transmit torque. The two side shaft gears are axially supported against the differential case 4 in opposite directions, in particular with a respective sliding disc interposed.

The disconnect clutch 5 is designed as a form-fitting clutch and is arranged in the differential housing 3 axially between a wall section 24 of the differential housing 3 and a wall section 25 of the differential case 4. The disconnect clutch has a first clutch part 26, which is connected to the differential housing 3 in a rotationally fixed and axially movable manner, and a second clutch part 27, which is fixedly connected to the differential case 4. The first coupling part 26 can have a toothed ring as a positive locking means, which is arranged in the differential housing 3. At its opposite end, the first coupling part 26 can have several force transmission portions 28, which pass through corresponding through-openings in the differential housing 3 and are operatively connected to an actuator of the ramp mechanism. The force transmission portions 28 can be designed in the form of axial projections, which are distributed around the circumference and can be formed in one piece with the toothed ring.

The second coupling part 27 has a corresponding toothed ring as a positive locking means, which is in particular formed in one piece on an end face of the differential case 4. In the present embodiment, the differential case 4 is constructed in two parts and comprises a first case part 29, in which the differential gear set is accommodated, and a second case part 30, in which the locking clutch is accommodated. The two case parts are firmly connected to each other, for example by welding. It is understood that the differential case can also be designed differently.

The disconnect clutch 5 can be opened or closed as desired by axially moving the first clutch part 26. The actuator unit 7 is designed in particular such that the first clutch part 26 can be brought into engagement with the second clutch part 27 by actuating the actuator drive in the closing direction, and out of engagement when the power is switched off. Spring means 32 are provided, which on one side are axially supported against the differential housing 3 and on the other side against a support portion 33 of the first clutch part 26 arranged outside the differential housing 3. In this way, the support portion 33 and the first clutch part 26, respectively, is acted upon axially by the spring means 32 in the direction toward the actuator. When the actuator is not actuated, the disconnect clutch 5 can thus assume a neutral position by means of the spring means 32, in which the clutch 5 is open.

The controllable locking clutch 6 for limiting the equalizing movement is designed in the form of a friction disc clutch. For this purpose, the locking clutch 6 comprises outer discs that are connected to an outer disc carrier in a rotationally fixed manner, and inner discs that are connected to an inner disc carrier in a rotationally fixed manner. The outer disc carrier is firmly connected to the differential case 4, in particular it is formed in one piece with the second case part 30. The inner disc carrier can be designed in the form of a hub part 34, which is connected to the side shaft 22 in a rotationally fixed manner. In this way, the inner discs are indirectly connected to the output part 19 of the differential in a rotationally fixed manner. The locking clutch 6 acts as a so-called shaft-case-lock.

The disc pack formed from the outer and inner discs is supported against a support face 35 of the differential case 4 and is acted upon axially by a pressure element 36. The pressure element 36 has a pressure ring portion arranged inside the second case part 30 and several pin portions 37 distributed over the circumference, which extend through axial through-holes in the differential case 4. The pin portions 37 can be acted upon axially by force transmission elements 38, which in turn extend axially through corresponding through-openings in the wall section 25 of the differential housing 3 and can also be referred to as second force transmission portions. The force transmission elements 38 can have a ring section within the differential housing 3, from which pin portions extend through the side wall of the differential housing 3 in the direction of the actuator.

The actuator assembly 7 comprises an axially movable first setting ring 39 for actuating the disconnect clutch 5 and an axially movable second setting ring 40 for actuating the locking clutch 6. The first and second setting rings 39 and 40 are arranged coaxially to one another outside the differential housing 3. The setting ring for the disconnect clutch 5 lies radially outside the setting ring for the locking clutch 6. The differential housing 3 has a wall section 24 with through-openings through which the force transmission portions 28 for actuating the disconnect clutch 5 and the force transmission elements 38 for actuating the locking clutch 6 extend.

In the present embodiment, the actuator assembly 7 comprises only one single actuator drive 51 for actuating the disconnect clutch 5 and the locking clutch 6. In this case, the disengagement or engagement function of the disconnect clutch 5 and the setting of the transmittable locking torque of the locking clutch 6 can be performed in an actuation sequence.

For this purpose, the actuator assembly 7 has a support ring 42, which is arranged coaxially to the axis of rotation A opposite the two setting rings 39, 40. The support ring 42 and the two setting rings 39, 40 form a ramp mechanism, wherein the support ring 42 forms an input ring with two sets of ramps on two diameters, and the setting rings 39, 40 form output rings with corresponding counter-ramps for controlling the two clutches. The two setting rings 39, 40 are each axially supported against an associated intermediate ring 44, 44' via an axial bearing 43, 43'. The intermediate rings 44, 44' transmit an introduced axial force to the respective associated force transmission element 28, 38 for actuating the disconnect clutch 5 and the locking clutch 6, respectively.

The ramp mechanism is designed such that a rotary movement of the support ring 42 is converted into an axial movement of the first and/or second setting ring 39, 40. The support ring 42 is axially supported against the differential housing 3 and is rotatingly drivable by the actuator drive 51 via a motor shaft and a pinion gearing 23. In contrast, the two setting rings 39, 40 are mounted in a housing portion 13 by means of a sliding connection 11 such that they are rotationally fixed and axially movable.

In the present embodiment, the ramp mechanism is designed in the form of a ball ramp mechanism, without being limited thereto. The support ring 42 has outer first ball grooves 45, which are opposite the ball grooves 46 of the first setting ring 39, and radially inner second ball grooves 45', which are axially opposite the ball grooves 46' of the second setting ring 40. The first balls 47 associated with the first setting ring 39 and the second balls 47' associated with the second setting ring 40 can be held in a shared ball cage 48.

The support ring 42 comprises a sleeve portion 49, via which the support ring is rotatably mounted on a sleeve portion 52 of the differential housing 3 by a radial bearing 50. The radial bearing 50 can be designed as a needle bearing, for example. At a rear side, the support ring 42 is axially supported against an intermediate element 54 via an axial bearing 53, which is axially supported against the differential housing 3 via a retaining ring.

The first spring means 32 are arranged so as to be effective between the first clutch part 26 and the differential housing 3, wherein the spring means 32 reset the first clutch part 26 when the actuator is not actuated, i.e. act axially in the direction away from the second clutch part 27. Correspondingly, second spring means 32' are arranged so as to be effective between the second force transmission element 38 and the differential housing 3, wherein the spring means 32’ act axially on the second force transmission elements in the direction of the support disc 42. The first and second spring means 32, 32' may comprise one or more disc springs, without being limited thereto.

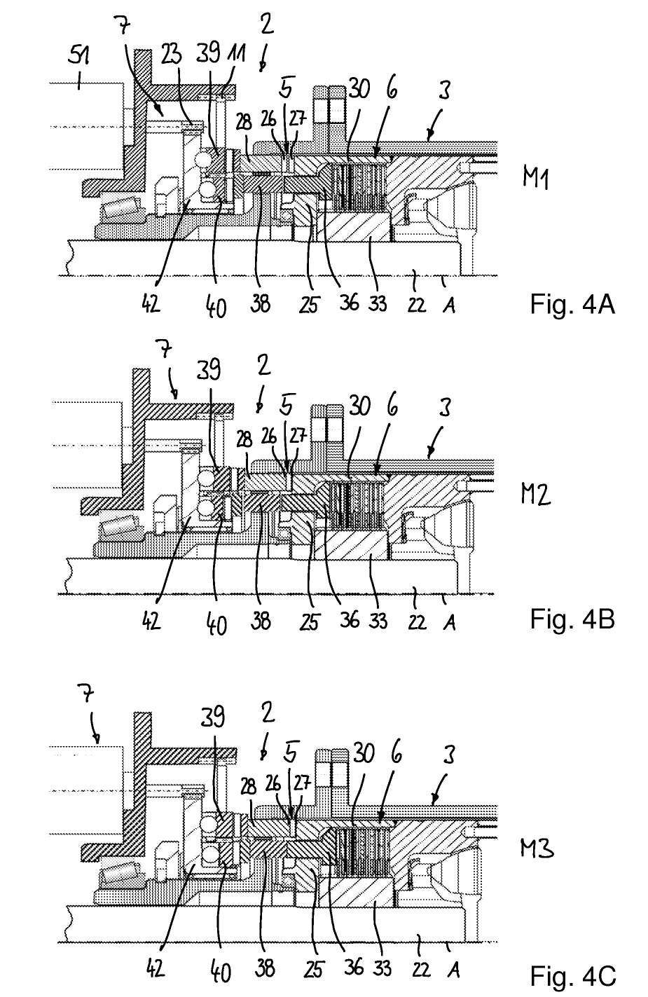

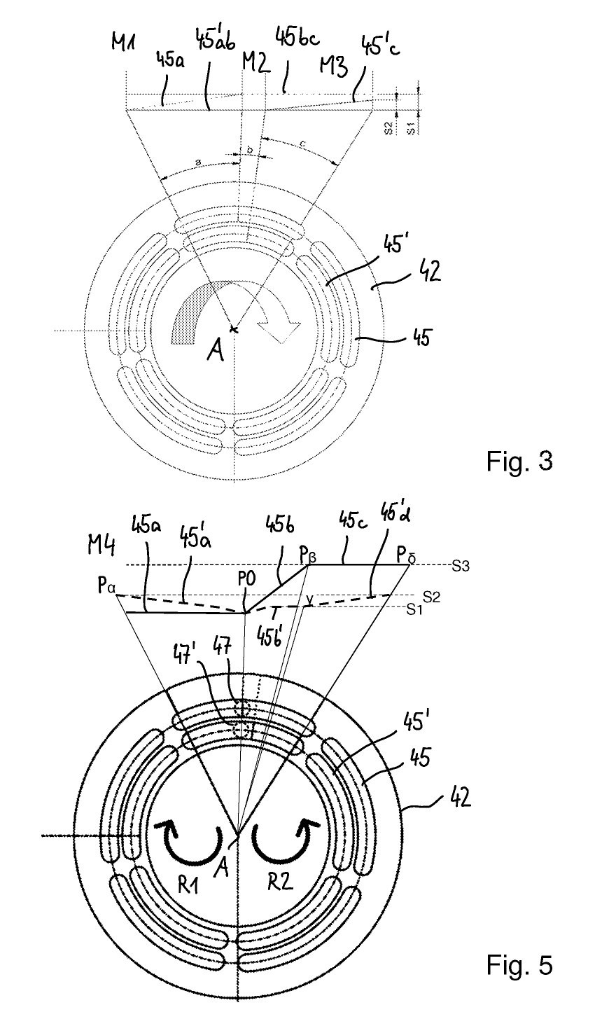

The mode of operation of the ramp assembly is explained below with reference to FIGS. 2 and 3, which schematically show an exemplary embodiment. FIG. 2 schematically shows a radially outer first ball groove 45 of the support ring 42 and a ball groove 46 of the first setting ring 39 co-operating therewith, as well as a radially inner second ball groove 45' of the support ring 42 with a ball groove 46' of the second setting ring 40 co-operating therewith. FIG. 3 shows an axial view of the support ring 42 of the ball ramp assembly. The radially outer first ball grooves 45 and the radially inner second ball grooves 45' can be seen. In the upper section of FIG. 3, the profiles of the first ball grooves 45 are shown as dashed lines and those of the second ball grooves 45' are shown as solid lines around the circumference.

The ball grooves 45, 45' of the support ring 42 and the ball grooves 46, 46' of the two setting rings 39, 40 are designed such that, starting from the non-actuated state in which the disconnect clutch 5 and the locking clutch 6 are both open, only the disconnect clutch 5 is initially closed in a first actuation range S1 and, in a subsequent second actuation range S2, the locking clutch 6 is also actuated in addition to the disconnect clutch 5.

Several first ball grooves 45 and second ball grooves 45' with different pitches and angular positions are distributed around the circumference. The first setting ring 39 for actuating the disconnect clutch 5 corresponds with the first ball grooves 45, and the second setting ring 40 for actuating the locking clutch 6 corresponds with the second ball grooves 45' of the support ring 42.

The first ball grooves 45 of the support ring 42 and/or the ball grooves 46 of the first setting ring 39 have a first groove section 45a with a circumferential extent a and a pitch not equal to zero, which is followed by a second groove section 45bc with a larger circumferential extent b + c and constant groove depth. The second ball grooves 45' of the support ring 42 and/or the ball grooves 46' of the second setting ring 40 have a first groove section 45'ab with a circumferential extension a + b and a constant groove depth and an adjoining second groove section 45'c with a shorter circumferential extension c and a non-zero pitch. The pitch of the second groove section 45'c of the second ball grooves 45' is smaller than the pitch of the first groove section 45a of the first ball grooves 45. The flat groove section 45'ab of the second ball grooves 45' and the flat groove section 45bc of the first ball grooves 45 have a certain overlap area b. This provides a neutral adjustment range in order to avoid tolerance influences.

The actuator assembly 7 can be used to set operating states that bring advantages in terms of driving dynamics, particularly in a drive axle driven by an electric motor. In a first operating state M1, which is shown in FIG. 4A, the actuator assembly 7 can be controlled so that the disconnect clutch 5 and the locking clutch 6 are both open. No torque is transmitted to the two output parts 19, 20 of the differential unit. In this operating state, the differential gear runs along with the vehicle axle without being driven, with an equalizing movement between the output gears, respectively the side shafts being possible.

In a second operating state M2, which is shown in FIG. 4B, the actuator assembly 7 can be controlled starting from the first operating state so that the disconnect clutch 5 is closed and the locking clutch 6 is open. In this operating state, the differential gear is driven by the motor and transmits the input drive power to the two output parts 19, 20, respectively side shafts connected thereto. The differential works as a so-called open differential, i.e. the two output parts 19, 20, respectively side shafts have an equalizing effect of the rotary movement therebetween.

In a third operating state M3, which is shown in FIG. 4C, the actuator assembly 7 can be controlled starting from the second operating state in such a way that, when the disconnect clutch 5 is closed, the locking clutch 6 is operated in order to generate a locking torque between the two output parts 19, 20 of the differential. The control can take place in two stages, as described in connection with FIG. 2. In the first sub-step S1, the disconnect clutch 5 is first closed, and in the second sub-step S2, the locking clutch is loaded in order to set the desired locking torque. Using the actuator assembly 7, the transmittable locking torque can be set and controlled as required according to driving dynamics requirements. Furthermore, torque can be transmitted to the output parts 19, 20, respectively the vehicle wheels with limited slip.

When the two clutches 5, 6 are opened again by the actuator assembly 7, the differential gearing and the locking clutch 6 rotate freely again. The friction losses occurring in the disconnected state are low, as the friction clutch 5 and the open differential rotate together as one block.

The disconnect clutch 5 can, for example, be designed to transmit torques of more than 1500 Nm, in particular more than 2000 Nm, and up to 5000 Nm (nominal torque). The locking clutch 6 can be designed to generate locking torques of more than 1000 Nm and less than 2500 Nm.

According to the following optional embodiments, a mean engagement diameter of the disconnect clutch 5 can be greater than a mean engagement diameter of the locking clutch 6. Furthermore, the disconnect clutch 5 and the locking clutch 6 can partially radially overlap, i.e. a smallest engagement diameter of the disconnect clutch 5 can be smaller than a largest engagement diameter of the locking clutch 6. The disconnect clutch 5 can be arranged axially between the side wall section 24 of the differential housing 3 and a side wall section 25 of the differential case 4.

FIG. 5 shows a support ring 42 with associated ramp profile for a differential assembly in a modified second embodiment. This corresponds in large parts to the embodiment according to FIGS. 1 - 4, to the description of which reference is made in this respect with regard to the similarities. The same and/or corresponding details are provided with the same reference signs as in the figures above.

A special feature of the embodiment according to FIG. 5 is that the actuator assembly 7 can realize a further operating state M4. For this purpose, it is provided that the input or support ring 42 can be rotated in a first direction of rotation R1 and an opposite second direction of rotation R2, starting from a central zero or neutral position P0, in which the two setting rings 39, 40 are axially approached to the support ring 42 and both couplings 5, 6 are correspondingly open.

When the input or support ring 42 is rotated in the first direction of rotation R1, in this case clockwise, both the balls 47 for the locking clutch 6 and the balls 47' for the disconnect clutch 5 pass through the respective groove section from the position P0 in the direction of the rotational position Pα. The groove sections 45a for the disconnect clutch 5 are straight, i.e. have no incline, while the groove sections 45'a for the locking clutch 6 have an incline. This has the effect that when the input or support ring 42 is rotated in the first direction of rotation R1, the output or setting ring 40 for the locking clutch 6 is moved axially away from the support ring into the position S2, so that the locking clutch 6 is engaged, while the setting ring 39 for the disconnect clutch 5 remains in the axially close position S1, so that the disconnect clutch 5 remains open. In this way, an additional function is realized in which the two output parts of the differential, respectively the two side shafts, are locked together with limited slip, while the drive motor remains decoupled from the side shafts. This enables a locking function to stabilize the vehicle during dynamic cornering, even when the drive motor is decoupled. The torque distribution between the two side shafts can be controlled in such a way that oversteering of the vehicle when cornering is reduced or prevented without the vehicle brakes having to intervene.

If the input or support ring 42 is rotated in the second direction of rotation R2, in this case anti-clockwise, the operating states can be set analogue to the design shown in FIG. 3. The balls 47 for the disconnect clutch 5 run from position P0 along the groove section 45b in the direction of the rotational position Pβ. This leads to an axial movement of the output or setting ring 39, which reaches position S3, so that the disconnect clutch 5 is completely closed. At the same time, the output or setting ring 40 is moved to position S1. The locking clutch 6 is thus in a temporary holding position in which the clutch play is largely bridged, but no locking torque is yet generated between the output parts. The differential is in an operating mode that can be described as an "open differential". If the input or support ring 42 is rotated further in the second direction of rotation R2 from the rotational position Pβ to the rotational position Pδ, the balls 47 of the first setting ring 39 run along pitchless groove sections 45c so that the disconnect clutch 5 remains fully closed. The balls 47' for the locking clutch 6 move along the ball ramps in the groove sections 45'b, so that the second setting ring 40 is moved axially from position S1 to position S2. This closes the locking clutch 6 or sets a locking torque between the two differential output parts. The size of the generated slip limitation mode essentially depends on the drive torque and the pitch of the ball ramps.

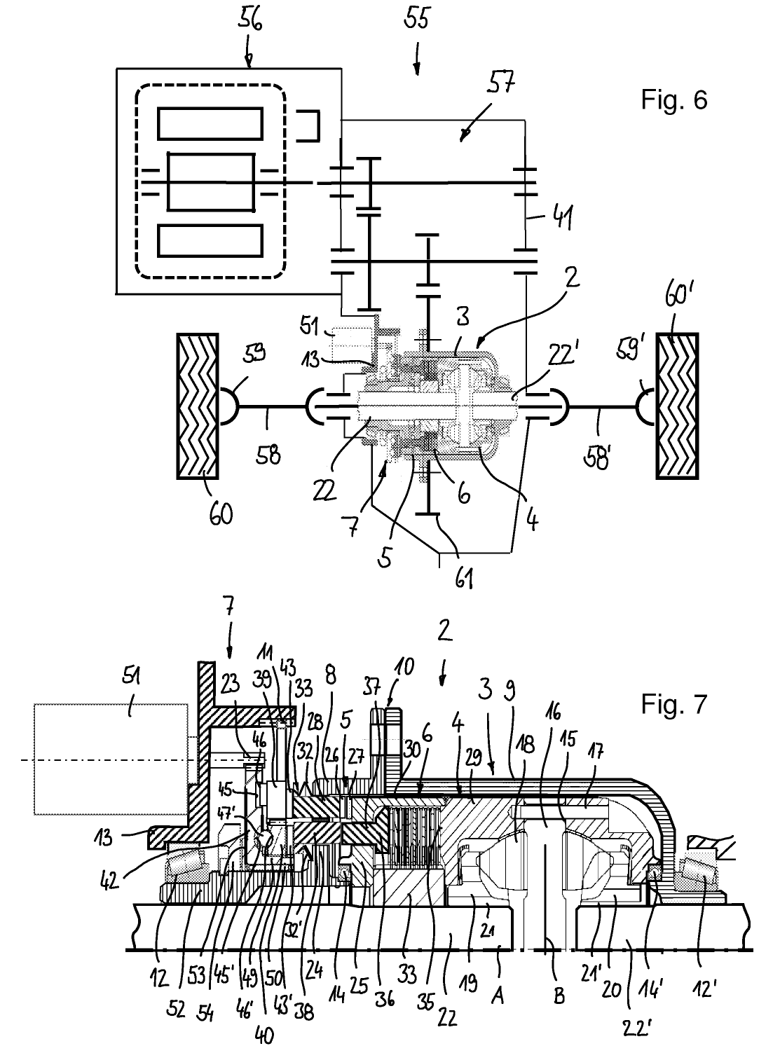

FIG. 6 shows a schematic representation of a drive assembly 55 with a differential unit 2 as shown in FIG. 1. The drive assembly 55 shown can be a secondary drive for a secondary drive axle of a motor vehicle, which can additionally comprise a primary drive for a primary drive axle. The primary drive and secondary drive can be mechanically separated from each other.

The drive assembly 55 comprises an electric machine 56 with a rotor and a stator, a downstream transmission unit 57, with which the motor torque is converted into a drive torque and, respectively, the motor speed is converted into a drive speed, and a differential unit 2 as shown in FIG. 1. The transmission unit 57 is designed as a reduction gearing and, in the present embodiment, comprises two gear shafts rotatably mounted in the transmission housing 41 and two pairs of spur gears, without being limited thereto. An input gear 61, which is firmly connected to the rotatable differential housing 3, is provided to initiate the rotary movement from the reduction gearing to the differential unit 2. When the disconnect clutch 5 is closed, the rotary motion introduced is transmitted from the differential unit 2 to the two output parts 19, 20 of the differential. Respective output shafts 22, 22' are inserted into the shaft splines of the output parts 19, 20 in a rotationally fixed manner to transmit torque. The output shafts 22, 22' are connected via associated side shafts 58, 58' to constant velocity joints 59, 59' for torque transmission to the wheels 60, 60' of the secondary drive axle 62.

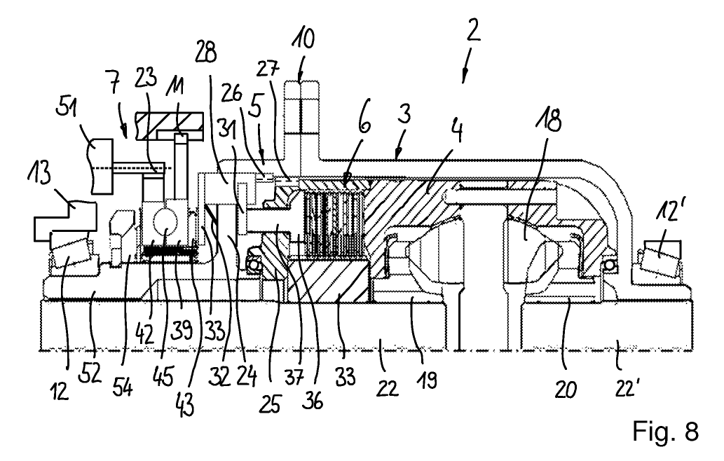

FIG. 7 shows a differential unit 2 in a modified embodiment. This corresponds in large parts to the embodiment according to FIGS. 1 - 4, to the description of which reference is made in this respect with regard to the similarities. The same and/or corresponding details are provided with the same reference signs as in the figures above.

A special feature of the embodiment according to FIG. 7 is that the ramp mechanism for actuating the disconnect clutch 5 is designed in the form of a sliding ramp mechanism. A rotational movement of the input or support ring 42 is transmitted via several pairs of sliding ramps extending in the circumferential direction to the first output or setting ring 39, which is moved axially accordingly. The setting ring 39 is held stationary in relation to a stationary component, but is axially movable. The pairs of sliding ramps formed between the support ring 42 and the setting ring 39 convert the rotary movement of the support ring 42 into an axial movement of the setting ring 39, which acts on the disconnect clutch 5. Any friction losses are negligible as the disconnect clutch 5 is designed as a form-fitting clutch. The ramp mechanism for actuating the locking clutch 6 is designed as a ball ramp mechanism, as in the embodiment shown in FIG. 1. The structure and mode of operation of the actuator assembly 7, in particular the design of the ramps for setting the various operating modes, can be designed as in FIGS. 1 - 4. In this respect, reference is made to the above description to avoid repetition.

FIG. 8 shows a differential unit 2 in a further embodiment. The present embodiment corresponds in large parts to the embodiment according to FIGS. 1 - 4, to the description of which reference is made in this respect with regard to the similarities. Identical and/or corresponding details are provided with the same reference signs as in the figures above.

A special feature of the present embodiment according to FIG. 8 is that only one output or setting ring 39 is provided, which actuates both the disconnect clutch 5 and the locking clutch 6 via the force transmission element 28. The ramp mechanism formed between the input or support ring 42 and the output or setting ring 39 is designed in such a way that the disconnect clutch 5 is closed in a first actuating range and the locking clutch 6 is also closed in a subsequent second actuating range. In order to provide sufficient axial travel, the disconnect clutch 5 in the present design is in the form of a toothed clutch, wherein the first clutch part 27 engages with its longitudinal toothing with the corresponding toothing of the second clutch part 26 during axial movement. The axial force generated by the ramp mechanism is transmitted from the force transmission element 28 via an intermediate element 31 to the pressure element 36, which acts on the locking clutch 6. The axial length of the coupling parts 26, 27 of the disconnect clutch 5 is long enough to cover the full actuating distance to close the locking clutch 6. An advantage of the present design is that particularly few parts are required and the installation space is small.

Certain embodiments or components or features of components have been noted herein as being "preferred" and some options as being “preferable” or the like and such indications are to be understood as relating to a preference of the applicant at the time this application was filed. Such embodiments, components or features noted as being "preferred" or “preferable” or the like are optional and are not required for implementation of the innovations disclosed herein unless otherwise indicated as being required, or specifically included within the claims that follow.

1. A differential unit for a motor vehicle, comprising
a differential housing which is rotatingly drivable about an axis of rotation,
a differential case rotatably mounted in the differential housing,
a plurality of differential gears rotating with the differential case and two output parts drivingly engaged with the differential gears, wherein the two output parts have a compensating effect on one another;
a controllable disconnect clutch for disconnecting or connecting torque transmission from the differential housing to the differential case, wherein the disconnect clutch is designed as a form-fitting clutch and is arranged axially within the differential housing between a wall section of the differential housing and a wall section of the differential case;
a controllable locking clutch for limiting the compensating movement between the two output parts, the locking clutch being designed in the form of a friction disc clutch which has outer discs connected in a rotationally fixed manner to the differential case and inner discs connected in a rotationally fixed manner to one of the output parts;
an actuator assembly with at least one axially movable setting ring for operating the disconnect clutch and for axially acting on the locking clutch, wherein the wall section of the differential housing has through openings through which axially movable force transmission portions extend for operating the disconnect clutch and acting on the locking clutch.

2. The differential unit according to claim 1, wherein the actuator assembly has one single actuator drive for operating the disconnect clutch and the locking clutch.

3. The differential unit according to claim 1, wherein the actuator assembly is designed such that it can establish a first operating state in which the disconnect clutch and the locking clutch are both open, so that no torque is transmittable to the two output parts of the differential unit.

4. The differential unit according to claim 3, wherein the actuator assembly is designed such that, starting from the first operating state, it can establish a second operating state in which the disconnect clutch is closed and the locking clutch is open.

5. The differential unit according to claim 4, wherein the actuator assembly is designed such that, starting from the second operating state, it can establish a third operating state in which, with the disconnect clutch closed, the locking clutch can be operated in order to set a locking torque between the two output parts of the differential unit.

6. The differential unit according to claim 3, wherein the actuator assembly is designed such that it can establish a further operating state in which the disconnect clutch is open and the locking clutch is closed, so that the two output parts of the differential unit rotate together with the differential case or limited by a demand-dependent controlled slipping torque, with the two output parts being decoupled from the drive.

7. The differential unit according to claim 1, wherein the actuator assembly has a ramp mechanism which comprises an axially supported support ring, the first setting ring and the second setting ring, wherein the support ring, the first setting ring and the second setting ring each comprise a plurality of ramps of variable depth over the circumference, which are designed such that a rotary movement introduced by the actuator drive is converted into an axial movement of the first or second setting ring.

8. The differential unit according to claim 7, wherein at least the ramps of the second setting ring for the locking clutch and the corresponding ramps of the support ring are designed in the form of ball grooves of variable depth over the circumference, in which balls are received.

9. The differential unit according to claim 8, wherein the ball grooves of the support ring and of the first and second setting rings are designed such that, by rotating the support ring relative to the two setting rings in a first relative direction of rotation, first the disconnect clutch and then the locking clutch are closed,
and that by rotating the support ring relative to the two setting rings in an opposite second relative direction of rotation, only the locking clutch is closed, while the disconnect clutch remains open.

10. The differential unit according to claim 1, wherein the disconnect clutch is designed to transmit torques of more than 2000 Nm and less than 5000 Nm, and
wherein the locking clutch is designed to generate locking torques of more than 1000 Nm and less than 2500 Nm.

11. The differential unit according to claim 1, wherein an average engagement diameter of the disconnect clutch is greater than an average engagement diameter of the locking clutch.

12. The differential unit according to claim 1, wherein the disconnect clutch and the locking clutch partially overlap radially.

13. The differential unit according to claim 1 in an electric drive for a drive axle of a motor vehicle, the electric drive comprising
an electric machine,
a reduction gearing located in a power path downstream of the electric machine,
wherein the differential unit is arranged in a power path downstream of the reduction gearing,
wherein the differential unit is designed to distribute a rotary movement generated by the electric machine and introduced via the interposed reduction gearing to the two output parts for driving a respective side shaft.
